(19) United States
(12) Patent Application Publication
(10) Pub. No.: US 2009/0231248 A1
(43) Pub. Date: Sep. 17, 2009

(54) APPARATUS AND METHODS FOR CONFIGURING THE COLOR OF A MOBILE COMPUTING DEVICE COVER

(75) Inventors: Ted E. Dorff, Santa Clara, CA (US); Mark A. Silvestri, Fremont, CA (US)

Correspondence Address: KACVINSKY LLC;4500 BROOKTREE ROAD, SUITE 102, WEXFORD, PA, 15090, US

(73) Assignee: PALM, INC., Sunnyvale, CA (US)

(21) Appl. No.: 12/048,604

(22) Filed: Mar. 14, 2008

(51) Int. Cl. G09G 3/32

(52) U.S. Cl. 345/83

(57) ABSTRACT

Various embodiments for configuring the color of a mobile computing device cover are described. In one embodiment, a mobile computing device may comprise a cover including a light-emitting diode (LED) array comprising a plurality of light-emitting diodes (LEDs). The mobile computing device may include a processor comprising an application for receiving preferences from a user for illuminating the cover and an LED array control module to generate color control signals based on the preferences. The color control signals may control the amount of current and voltage supplied to individual LEDs of the LED array for achieving certain and relative intensities of light emitted by the LED array corresponding to a color selected from a plurality of available colors. Other embodiments are described and claimed.

### BACKGROUND

A mobile computing device such as a combination handheld computer and mobile telephone or smart phone generally may provide voice and data communication functionality as well as computing and processing capabilities. In many cases, mobile computing devices may be offered in a wide variety of colors to allow a user to purchase a mobile computing device having a desired appearance. A user also may change the appearance of a mobile computing device by purchasing and attaching a skin or a case that is made from plastic or rubber material in a desired color.

Each different colored mobile computing device and each different skin or case typically is assigned its own stock keeping unit (SKU). In general, SKUs are used in inventory management applications for identifying distinct products and for tracking products through the supply chain. Having different SKUs for products that otherwise function identically adds complexity to inventory management. In addition, high overhead costs are involved with maintaining a large inventory of products in several colors. To control overhead, products may be offered only in a limited number of colors which may not include the exact color desired by the purchaser.

### BRIEF DESCRIPTION OF THE DRAWINGS

FIG. 1 illustrates one embodiment of a mobile computing device.

FIG. 2 illustrates one embodiment of a mobile computing device.

FIG. 3 illustrates an exemplary user interface.

FIG. 4 illustrates an exemplary user interface.

FIG. 5 illustrates one embodiment of a logic diagram.

### DETAILED DESCRIPTION

Various embodiments for configuring the color of a mobile computing device cover are described. Numerous specific details are set forth to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

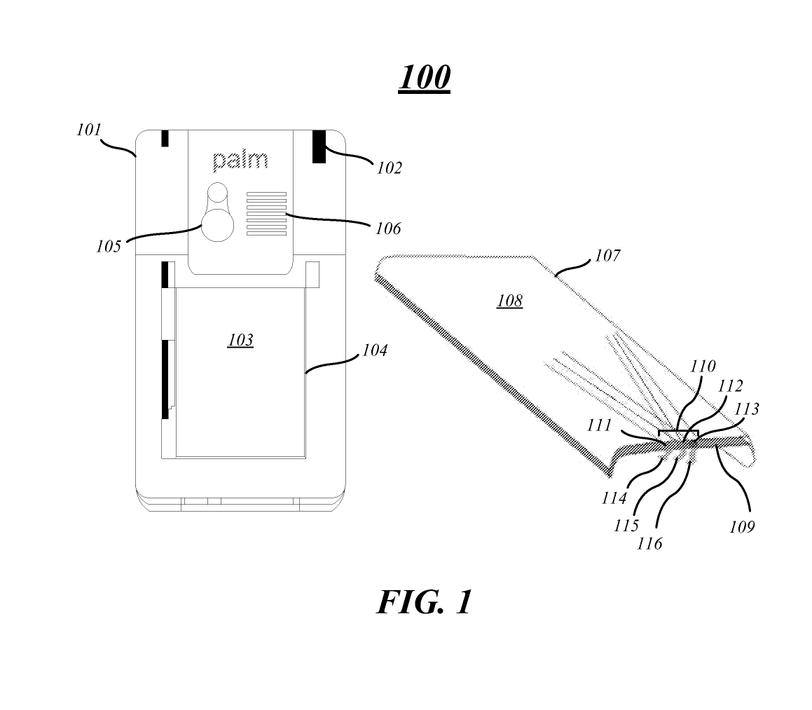

FIG. 1 illustrates a mobile computing device 100 suitable for implementing various embodiments. The mobile computing device 100 may be implemented as a combination handheld computer and mobile telephone, sometimes referred to as a smart phone. Examples of smart phones include, for example, Palm® products such as Palm® Treo™ smart phones. Although some embodiments may be described with the mobile computing device 100 implemented as a smart phone by way of example, it may be appreciated that the mobile computing device 100 may be implemented as other types of user equipment (UE) or wireless computing devices such as a handheld device, personal digital assistant (PDA), mobile telephone, combination mobile telephone/PDA, mobile unit, subscriber station, game device, messaging device, media player, pager, or any other suitable computing device in accordance with the described embodiments.

The mobile computing device 100 may comprise a housing 101 encapsulating components such as an antenna 102, a removable and rechargeable battery 103 within a battery compartment 104, a camera 105, a speaker 106, as well as a printed circuit board (PCB), one or more processors (e.g., host processor, radio processor, modem processor, baseband processor), memory (e.g., volatile or non-volatile memory, removable or non-removable memory, erasable or non-erasable memory, writeable or re-writeable memory), one or more transceivers (e.g., voice communications transceiver, data communications transceiver, GPS transceiver), and others. The housing 101 may be formed from materials such as plastic, metal, ceramic, glass, carbon fiber, various polymers, and so forth, suitable for enclosing and protecting the internal components of the mobile computing device 100. In various embodiments, the housing 101 may have a shape, size and/or form factor capable of being held with an average human hand.

The mobile computing device 100 may comprise a cover 107. In various embodiments, the cover 107 may comprise a detachable plastic battery cover designed to engage with the housing 101 on the back of the mobile computing device 100 and to enclose the battery 103 within the battery compartment 104. As shown, the cover 107 may comprise an outer layer 108, an inner layer 109, and a light-emitting diode (LED) array 110 positioned between the outer layer 108 and the inner layer 109. In general, the cover 107 may be designed so that the separation between the outer layer 108 and the inner layer 109 is sufficient to accommodate the LED array 110 while being as small as possible (e.g., a few millimeters) to preserve the form factor of the mobile computing device 100. While the LED array 110 may be implemented by the cover 107 (e.g., back battery cover) in some embodiments, it can be appreciated that the LED array 110 may be used in any suitable location within the mobile computing device 100 in accordance with the described embodiments.

As shown, the LED array 110 may comprise a plurality of light sources such as LEDs 111-113. The LEDs 111-113 may be implemented by miniature (e.g., single die) LEDs having a size of only a few millimeters. Each of the LEDs 111-113 may be arranged to receive power from the battery 103 or other power supply within the mobile computing device 100. For example, the LED array 110 may comprise spring connectors 114-116 corresponding to each of the LEDs 111-113 for establishing an electrical connection to a power supply when the cover 107 is attached. It can be appreciated that the LED array 110 may be implemented using various configurations (e.g., common anode, common cathode) of LEDs 111-113 and may employ other suitable connection mechanisms in accordance with the described embodiments.

While a single LED array 110 may be suitable for some embodiments, the mobile computing device 100 may comprise multiple LED arrays in various implementations. For example, the cover 107 may comprise the LED array 110 positioned at one end and a second LED array positioned at the opposite end. In such implementations, both LED arrays may utilize the same set of spring connectors 114-116 by connecting the LEDs of the second LED array to the spring connectors 114-116 with very thin wires running through the plastic inner layer 109. It can be appreciated that wiring in this way will not obstruct the light emitted by either of the LED arrays.

It also can be appreciated that any suitable number of LED arrays may be implemented and positioned in various ways depending on the size of the cover 107 or other design factors of the mobile computing device 100. In general, multiple LED arrays may be configured to cooperate with each other. In some cases, multiple LED arrays may behave identically when working together. In other cases, multiple LEDs may behave differently while still cooperating to achieve a desired effect.

As shown, the LED array 110 may be positioned at the end of the cover 107. When powered, the LED array 110 may radiate or disburse light into the cover 107 between the outer layer 108 and the inner layer 109. The light emitted by the LED array 110 may be diffused and spread out within the open space defined by the cover 107. In various embodiments, the outer layer 108 may comprise a semi-opaque or translucent plastic material such that the light emitted by the LED array 110 is viewable through the outer layer 108. The inner layer 109 may comprise a highly reflective and completely opaque material for reflecting and diffusing the light within the cover 107. In such embodiments, when the LED array 110 is on, the light emitted by the LED array 110 may be reflected by the inner layer 109 and visible through the outer layer 108 so that the cover 107 is illuminated by and appears to be the color produced by the LED array 110. On the other hand, when the LED array 110 is off, the cover 107 is not illuminated and appears to be its actual semi-opaque (e.g., milky white) or translucent color.

In various embodiments, each of the LEDs 111-113 may comprise a different primary color LED. For example, the LED 111 may comprise a red LED, the LED 112 may comprise a green LED, and the LED 113 may comprise a blue LED. The color of the light emitted by each of the LEDs 111-113 depends on the composition the semiconductor material used to form each LED. For example, a red LED may comprise semiconductor material such as Gallium Phosphide (GaP), Gallium Arsenide Phosphide (GaAsP), and Aluminium Gallium Arsenide (AlGaAs). A green LED may comprise semiconductor material such as GaP, AlGaAs, Aluminium Gallium Phosphide (AlGaP), Aluminium Gallium Indium Phosphide (AlGaInP), and Gallium Nitride (GaN). A blue LED may comprise semiconductor material such as GaN, Indium Gallium Nitride (InGaN), Zinc Selenide (ZnSe), Silicon Carbide (SiC) substrate, Silicon (Si) substrate, and Sapphire (Al₂O₃) substrate.

Each of the LEDs 111-113 of the LED array 110 may be configurable to emit light of a different primary color (e.g., red, green, and blue) within a range of intensities. In various embodiments, each of the LEDs 111-113 may comprise a semiconductor diode that emits light when electrically biased in the forward direction. For example, each of the LEDs 111-113 may be forward-biased by applying an appropriate voltage across its p-n junction so that current flows through the LED, and the LED emits light. In general, the amount of light emitted by each of the LEDs 111-113 corresponds to the current flowing through the LED.

In various embodiments, the amount of current and voltage supplied to each of the LEDs 111-113 may be individually controlled so that the LED array 110 is configured to achieve a certain combination of primary colors at certain intensities and to produce one of a wide variety of available colors. By combining the primary colored lights emitted by the LEDs 111-113 at different intensities, the LED array 110 may be capable of producing a vast number of available colors. Accordingly, the mobile computing device 100 may be assigned a single SKU for inventory management purposes while providing the ability to configure the mobile computing device 100 with an almost unlimited number of colors. The mobile computing device 100 also may allow the user to set preferences for displaying one or more colors and for controlling visual effects such as brightness, blinking, changing among colors, and so forth.

In various implementations, the available colors and hues capable of being produced by the LED array 110 to illuminate the cover 107 may comprise a set of colors based on an additive color model such as a (Red-Green-Blue) RGB color model. In accordance with the RGB color model, for example, each available color may be made up of a certain ratio or relative amounts of red, green, and blue light emitted by the LED array 110. In turn, each available color may be associated with certain defined set of RGB color values (Rᵥₐₗ, Gᵥₐₗ, Bᵥₐₗ) which corresponds to the ratio or relative amounts of red, green, and blue for the color. The RGB color values for each available color may be represented numerically or alphanumerically (e.g., hexadecimal character string).

When represented numerically, each of the RGB color values may vary between a minimum color value for zero intensity and a maximum color value for full intensity. Each RGB color value may be indicated by a percentage (e.g., 0% to 100%), a number falling within a particular range (e.g., 0 to 1), a binary notation (e.g., 0 to 255), or in any other manner in accordance with the described embodiments. For instance, the set of RGB colors values (Rᵥₐₗ, Gᵥₐₗ, Bᵥₐₗ) for the primary color red may be represented numerically as (100%, 0%, 0%), (1, 0, 0), or (255, 0, 0), for example. Using numeric binary notation, for example, the primary color green may be represented by the set of RGB color values (0, 255, 0), and the primary color blue may be represented by the set of RGB color values (0, 0, 255). It can be appreciated that each primary color may be produced by using the maximum color value of the desired primary color and the minimum color values of the other primary colors.

Other available colors may be represented using combinations of maximum and minimum RGB color values. Using binary notation, for example, the set of RGB color values (0, 0, 0) represents black, the set of RGB color values (255, 255, 255) represents white, the set of RGB color values (255, 255, 0) represents yellow, the set of RGB color values (0, 255, 255) represent cyan, and the RGB set of color values (255, 0, 255) represents magenta. It can be appreciated that eight different colors may result just by using the maximum and minimum color values.

Furthermore, a vast number of available colors may be represented using combinations of primary colors at various intensities. Using binary notation, the color pink may be represented by the set of RGB color values (255, 192, 203), the color purple may be represented by the set of RGB color values (160, 32, 240), and the color turquoise may be represented by the set of RGB color values (64, 224, 208). While certain exemplary colors and their corresponding sets of RGB color values have been identified, it is to be understood that the LED array 120 may be configured to produce any color capable of being represented by a set RGB color values.

To produce an available color represented by a combination of maximum and minimum RGB color values, the mobile computing device 100 may be arranged to switch certain LEDs of the LED array 110 on and off and to apply a constant current only to those LEDs that are on. To produce an available color represented by a combination of primary colors at intermediate intensities, the mobile computing device 100 may be arranged to precisely control the current to each of the LEDs 111-113 to achieve the exact ratio or relative amounts of red, green, and blue light for the desired color.

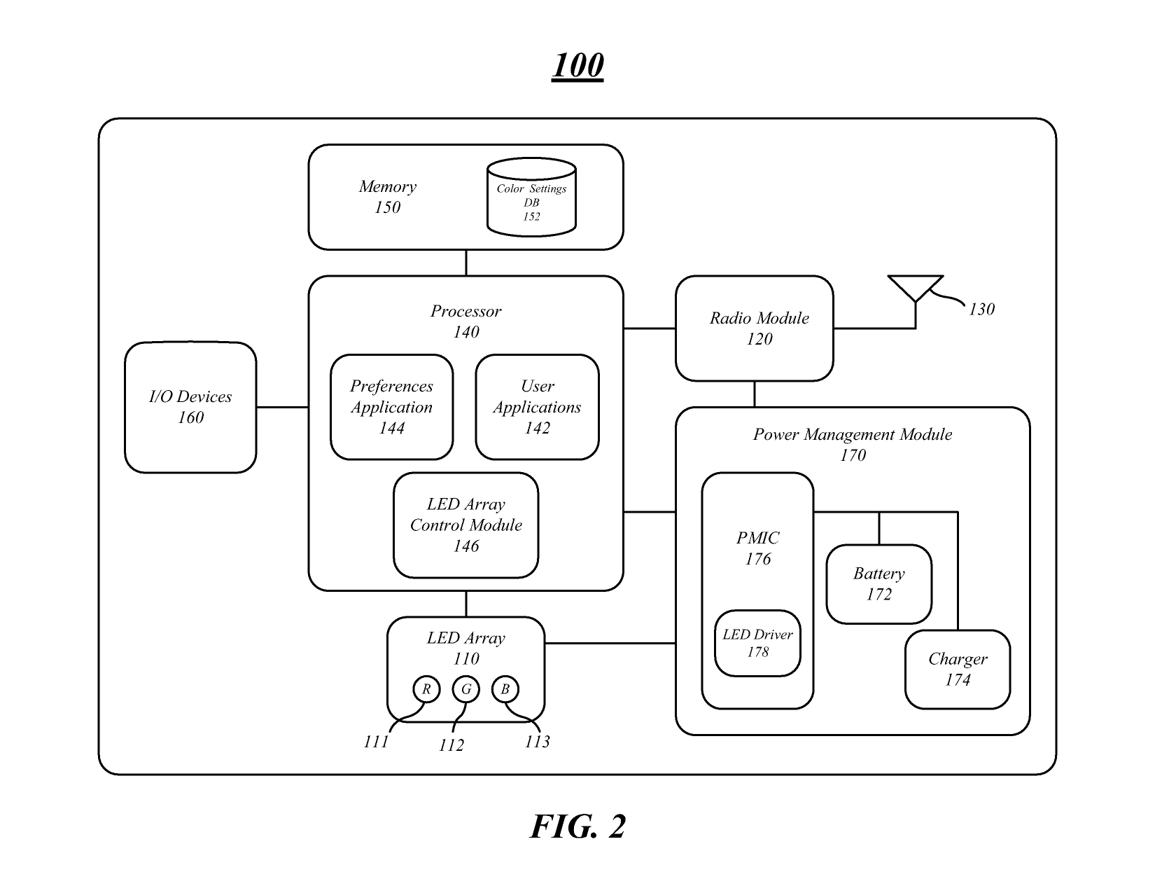

FIG. 2 illustrates a block diagram of the mobile computing device 100 in accordance with one or more embodiments. The mobile computing device 100 generally may be configured to support or provide cellular voice communication, wireless data communication, and various computing capabilities.

The mobile computing device 100 may support cellular voice communication with a mobile network such as a Code Division Multiple Access (CDMA) network, Global System for Mobile Communications (GSM) network, North American Digital Cellular (NADC) network, Time Division Multiple Access (TDMA) network, Extended-TDMA (E-TDMA) network, Narrowband Advanced Mobile Phone Service (NAMPS) network, third generation (3G) network such as a Wide-band CDMA (WCDMA) network, CDMA-2000 network, Universal Mobile Telephone System (UMTS) network, and others.

The mobile computing device 100 may support wireless wide area network (WWAN) data communication including Internet access. Examples of WWAN data communication services may include Evolution-Data Optimized or Evolution-Data only (EV-DO), Evolution For Data and Voice (EV-DV), CDMA/1xRTT, GSM with General Packet Radio Service systems (GSM/GPRS), Enhanced Data Rates for Global Evolution (EDGE), High Speed Downlink Packet Access (HSDPA), High Speed Uplink Packet Access (HSUPA), and others.

The mobile computing device 100 may support wireless local area network (WLAN) data communication in accordance with the Institute of Electrical and Electronics Engineers (IEEE) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, and others.

The mobile computing device 100 also may support data communication in accordance with shorter range wireless networks, such as a wireless personal area network (PAN) offering Bluetooth® data communication services in accordance with the Bluetooth® Special Interest Group (SIG) series of protocols, specifications, profiles, and so forth. Other examples of shorter range wireless networks may employ infrared (IR) techniques or near-field communication techniques and protocols, such as electro-magnetic induction (EMI) techniques including passive or active radio-frequency identification (RFID) protocols and devices.

As shown in FIG. 2, the mobile computing device 100 may comprise, by way of example, a radio module 120, an antenna system 130, a processor 140, memory 150, input/output (I/O) devices 160, and a power management module 170. Although some embodiments may be illustrated and described as comprising exemplary functional components and/or modules performing various operations, it can be appreciated that such components or modules may be implemented in hardware, software, firmware, or in any combination thereof. In addition, while a limited number of functional components and/or modules may be shown for purposes of illustration, it can be appreciated that the mobile computing device 100 may include other elements in accordance with the described embodiments.

The radio module 120 may comprise various radio elements, including a radio processor, one or more transceivers, amplifiers, filters, switches, and so forth. The radio module 120 may be arranged to provide voice and/or data communication functionality for the mobile computing device 100 for operating in accordance with different types of wireless network systems. It may be appreciated that the radio module 120 may utilize different radio elements to implement different communication techniques.

The antenna system 130 may comprise or be implemented as one or more internal antennas (e.g., antenna 104) and/or external antennas for transmitting and receiving electrical signals. In some embodiments, the antenna system 130 may support operation of the mobile computing device 100 in multiple frequency bands or sub-bands such as the 2.4 GHz range of the ISM frequency band for WiFi and Bluetooth® communications, one or more of the 850 MHz, 900 MHZ, 1800 MHz, and 1900 MHz frequency bands for GSM, CDMA, TDMA, NAMPS, cellular, and/or PCS communications, the 2100 MHz frequency band for CDMA2000/EV-DO and/or WCDMA/UMTS communications, the 1575 MHz frequency band for Global Positioning System (GPS) operations, and others.

The processor 140 may comprise a general purpose processor or an application specific processor arranged to provide general or specific computing capabilities for the mobile computing device 100. In some implementations, the mobile computing device 100 may comprise a dual processor architecture including the processor 140 and a radio processor implemented by the radio module 120 that communicate with each other using interfaces such as one or more universal serial bus (USB) interfaces, micro-USB interfaces, universal asynchronous receiver-transmitter (UART) interfaces, general purpose input/output (GPIO) interfaces, control/status lines, control/data lines, audio lines, and so forth. It may be appreciated that the mobile computing device 100 may use any suitable number of processors in accordance with the described embodiments.

In general, the processor 140 may perform operations associated with higher layer protocols and applications. Such applications generally may provide various user interfaces (UIs) to communicate information between the mobile computing device 100 and a user. Application programs may comprise upper layer programs running on top of the operating system (OS) of the processor 140 that operate in conjunction with the functions and protocols of lower layers including, for example, a transport layer such as a Transmission Control Protocol (TCP) layer, a network layer such as an Internet Protocol (IP) layer, and a link layer such as a Point-to-Point (PPP) layer used to translate and format data for communication.

The processor 140 may provide various user applications 142, such as messaging applications, web browsing applications, personal information management (PIM) applications (e.g., contacts, calendar, scheduling, tasks), Virtual Private Network (VPN) applications, word processing applications, spreadsheet applications, database applications, media applications (e.g., video player, audio player, multimedia player, digital camera, video camera, media management), location based services (LBS) applications, gaming applications, and so forth. Examples of messaging applications may include without limitation a cellular telephone application, a voicemail application, a Voice-over-Internet Protocol (VoIP) application, a facsimile application, an e-mail application, a short message service (SMS) application, a multimedia message service (MMS) application, a video teleconferencing application, a push-to-talk (PTT) application, a push-to-video application, Text-to-Speech (TTS) application, an instant messaging (IM) application, and so forth. It is to be appreciated that the mobile computing device 100 may implement other types of applications in accordance with the described embodiments.

The processor 140 also may provide functional utilities that are available to various protocols, operations, and/or applications. Examples of such utilities include operating systems, device drivers, programming tools, utility programs, software libraries, application programming interfaces (APIs), and so forth. Exemplary operating systems may include, for example, a Palm OS®, Palm OS® Cobalt, Microsoft® Windows OS, Microsoft Windows® CE OS, Microsoft Pocket PC OS, Microsoft Mobile OS, Symbian OS™, Embedix OS, Linux OS, Binary Run-time Environment for Wireless (BREW) OS, JavaOS, a Wireless Application Protocol (WAP) OS, and so forth.

The memory 150 may comprise computer-readable storage media such as volatile or non-volatile memory units arranged to store programs and data for execution and/or use by the mobile computing device 100. For example, the memory 150 may store executable program instructions, code or data capable of being retrieved and executed by the processor 140 to provide operations for the mobile computing device 100. The memory 150 also may implement various databases and/or other types of data structures (e.g., arrays, files, tables, records) for storing data for use by the processor 140 and/or other elements of the mobile computing device 100.

The I/O devices 160 may comprise various devices for receiving input from and displaying content to a user of the mobile computing device 100 such as a display for presenting UIs and a keypad for inputting data, for example. The keypad may be implemented by an alphanumeric keypad having a QWERTY key layout and an integrated number dial pad. The keypad may comprise a physical keypad and/or a virtual keypad using soft buttons displayed on the display. The display may be implemented by a liquid crystal display (LCD) such as a touch-sensitive, color, thin-film transistor (TFT) LCD or other type of suitable visual interface for displaying content to a user of the mobile computing device 100. The mobile computing device 100 may comprise various other I/O devices 160 including keys (e.g., input keys, preset and programmable hot keys), buttons (e.g., left and right action buttons, a multidirectional navigation button, phone/send and power/end buttons, preset and programmable shortcut buttons), switches (e.g., volume rocker switch, a ringer on/off switch having a vibrate mode), a microphone, speakers, an audio headset, a camera, a stylus, and so forth.

The power management module 170 may be arranged to supply and/or manage power for the mobile computing device 100, including the radio module 120, the processor 140, and other elements of mobile computing device 100. For example, the power management module 170 may comprise a battery 172 (e.g., removable and rechargeable battery 103) for supplying direct current (DC) power as well as a charger 174 including an alternating current (AC) interface to draw power from an AC power source, such as a standard AC main power supply. In various implementations, the power management module 170 may comprise a power management integrated circuit (PMIC) 176 comprising circuitry and/or logic for distributing power from the battery 172 and/or charger 174 to the other elements of the mobile computing device 100. In such implementations, the PMIC 176 may supply power to one or more elements of the mobile computing device 100 via power I/O interfaces. In some cases, certain elements of the mobile computing device 100 may act as a power supply for other elements. For example, the processor 140 may comprise some I/O power interfaces for receiving power from the PMIC 176 and other I/O power interfaces for supplying power to elements of the mobile computing device 100 such as the radio module 120, the memory 150, the I/O devices 160 (e.g., LCD, keypad, camera, speakers, etc.), and others.

In various embodiments, the mobile computing device 100 may allow the user to set various global and/or application preferences for illuminating the cover of the mobile computing device 100. As shown, the processor 140 may comprise a preferences application 144 for presenting one or more UIs for receiving input from the user of the mobile computing device 100. The user may view, input, and modify color preferences via the UIs using I/O devices 160 such as a display, keyboard, and stylus, for example. After being input by the user, the color preferences may be stored in a color settings database 152 within the memory 150 or other suitable computer-readable storage media.

In some implementations, the UIs for setting the color preferences may be accessible from the preferences application 144 as well from one or more user applications 142. For example, certain user applications 142 (e.g., messaging application, PIM application, media application, LBS application, gaming application, etc.) may include a menu item for allowing the user to associate one or more colors and/or visual effects with certain operations.

The UIs may allow the user to select a desired color for illuminating the cover of the mobile computing device 100. In general, the desired color may be selected from a wide variety of available colors and hues such as a set of colors based on an additive color model (e.g., RGB color model). In some cases, the available colors may comprise all colors capable of being represented by a set of RGB color values. In other cases, the number of available colors may be limited based on the performance constraints of the mobile computing device 100 and/or as desired for a particular implementation. The UIs also may allow the user to set preferences for controlling visual effects such as brightness, blinking, changing among colors, and so forth.

In some embodiments, the UIs may allow the user to select a desired color by choosing from a pick list of available color names. The UIs also may comprise a palette, a two or three dimensional grid of possible colors allowing user to select a point on the grid to choose a precise color, or other visual representation (e.g., spectrum, color wheel, color triangle, chromaticity diagram, etc.) including samples of available colors for allowing the user to select a desired color. The UIs may comprise various data entry fields and/or tools (e.g., slider bars, dials, etc.) for allowing the user to input and adjust values such as RGB color values (e.g., percentages, range values, binary notations) and visual effects (e.g., brightness) for a desired color.

In some implementations, a set of RGB color values may be associated with or mapped to a selected color such that selecting a desired color by name or from the palette automatically populates the data entry fields with its associated set of RGB color values. Likewise, choosing a certain set of RGB values may automatically display the name of the corresponding color. In some embodiments, the color preferences stored in the color settings database 152 may comprise a numeric or alphanumeric representation of the set of RGB color values corresponding to a selected color.

The UIs may allow the user to configure various conditions for illuminating the cover of the mobile computing device 100. In some cases, the mobile computing device 100 may be illuminated constantly. In other cases, the mobile computing device 100 may illuminate based on certain conditions or events. For example, the mobile computing device 100 may be configured to illuminate when a certain amount of power is available, when the mobile computing device 100 is in use, during certain time intervals, and/or on demand in response to selecting a certain key or button, tapping the screen, and so forth.

The UIs may allow the user to set preferences for configuring the mobile computing device 100 to illuminate in response to one or more user applications 142. For example, the user may configure the mobile computing device 100 to illuminate based on various events associated with the user applications 142. Exemplary events may include, without limitation, a reminder associated with a calendar application, an alarm associated with clock application, an incoming message associated with an e-mail, SMS or MMS application, an incoming or missed call from a known, unknown, or particular caller associated with a telephone application, a notification associated with a voicemail application, a song or video associated with a media application, an alert associated with a LBS application, a move or action associated with a gaming application, and/or any other event in accordance with the described embodiments.

The mobile computing device 100 also may comprise one or more sensors for the causing the mobile computing device 100 to illuminate in response to various environmental conditions. For example, the I/O devices 160 may comprise a light sensor for causing the mobile computing device 100 to illuminate in response to darkness, a sound sensor for causing the mobile computing device 100 to illuminate in response to noise, and a motion sensor for causing the mobile computing device 100 to illuminate in response to movement.

As shown, the mobile computing device 100 may comprise one or more LED arrays, such as the LED array 110, for illuminating the cover. The LED array 110 may comprise a plurality of light sources, such as LEDs 111-113. In this embodiment, the LED 111 may comprise a red LED, the LED 112 may comprise a green LED, and the LED 113 may comprise a blue LED. In general, the mobile computing device 100 may comprise hardware, software, firmware, and/or a combination thereof for individually controlling the amount of current and voltage supplied to each of the LEDs 111-113 to achieve a certain combination of primary colors at certain intensities. By combining the primary colored lights emitted by the LEDs 111-113 at different intensities, the LED array 110 may be capable of producing a vast number of available colors.

As shown, the mobile computing device 100 may comprise or implement a LED array control module 146 and an LED driver 178. In one embodiment, the LED array control module 146 may comprise software to be executed by the processor 140 for generating color control signals corresponding to relative intensities of red, green, and blue light associated with a selected color and visual effect (e.g., brightness). The LED driver 178 may comprise circuitry and/or logic implemented by the PMIC 176 for receiving the color control signals and for outputting regulated and/or adjustable output voltage and current supplied by a power source (e.g., battery 172) to each of the LEDs 111-113 of the LED array 110. Accordingly, the LEDs 111-113 of the LED array 110 may be driven by the output voltage and current to produce a combination of primary colors at certain intensities resulting in the selected color and visual effect.

It can be appreciated that FIG. 2 depicts an exemplary implementation for purposes of illustration and that various configurations of hardware, software, and/or firmware may be employed to control the current and voltage supplied to each of the LEDs 111-113 of the LED array 110 in accordance with the described embodiments. For example, in some embodiments, the LED array control module 146 may be implemented by or form part of one of the user applications 142 and/or the preferences application 144. In some embodiments, the LED driver 178 may be implemented by the LED array 110, the processor 140, and/or a separate IC or microcontroller.

In various implementations, the LED array control module 146 may generate color control signals in response to preferences set by the user. For example, the LED array control module 146 may access color preferences stored in the color settings database 152 to determine various colors and conditions for illuminating the mobile computing device 100 and may generate color control signals based on certain conditions or events. The LED array control module 146 also may generate color control signals in response to one or more user applications 142 and/or various events associated with the user applications 142.

In general, the color control signals generated by the LED array control module 146 may control the switching of the LEDs 111-113 on and off and the amount of current supplied to each of the LEDs 111-113 for achieving certain and relative intensities of red, green, and blue light emitted by the LED array 110 corresponding to a selected color and effect. The intensity of the light emitted by of each of the LEDs 111-113 may be adjusted by lowering a constant current supplied to each of the LEDs 111-113. Accordingly, in some embodiments, the color control signals generated by the LED array control module 146 may comprise current limiting signals corresponding to each of the LEDs 111-113 for adjusting the intensity of the red, green, and blue light emitted by the LED array 110 and for achieving relative intensities among the red, green, and blue light emitted by the LED array 110.

The intensity of the light emitted by each of the LEDs 111-113 also may be adjusted by controlling the switching frequency and limiting the amount of time each of the LEDs 111-113 is on during a given period. Accordingly, in some embodiments, the color control signals generated by the LED array control module 146 may comprise pulse width modulation (PWM) signals corresponding to each of the LEDs 111-113 for adjusting the intensity of the red, green, and blue light emitted by the LED array 110 and for achieving relative intensities among the red, green, and blue light emitted by the LED array 110. In such embodiments, the PWM signals may achieve lower intensities by controlling the switching of the LEDs 111-113 so that each of the LEDs 111-113 is only on for a certain portion of a period or for a defined cadence. The PWM signals may achieve relative intensities among the red, green, and blue light by controlling the amount of time during the period that each of the LEDs 111-113 is on with respect to one another.

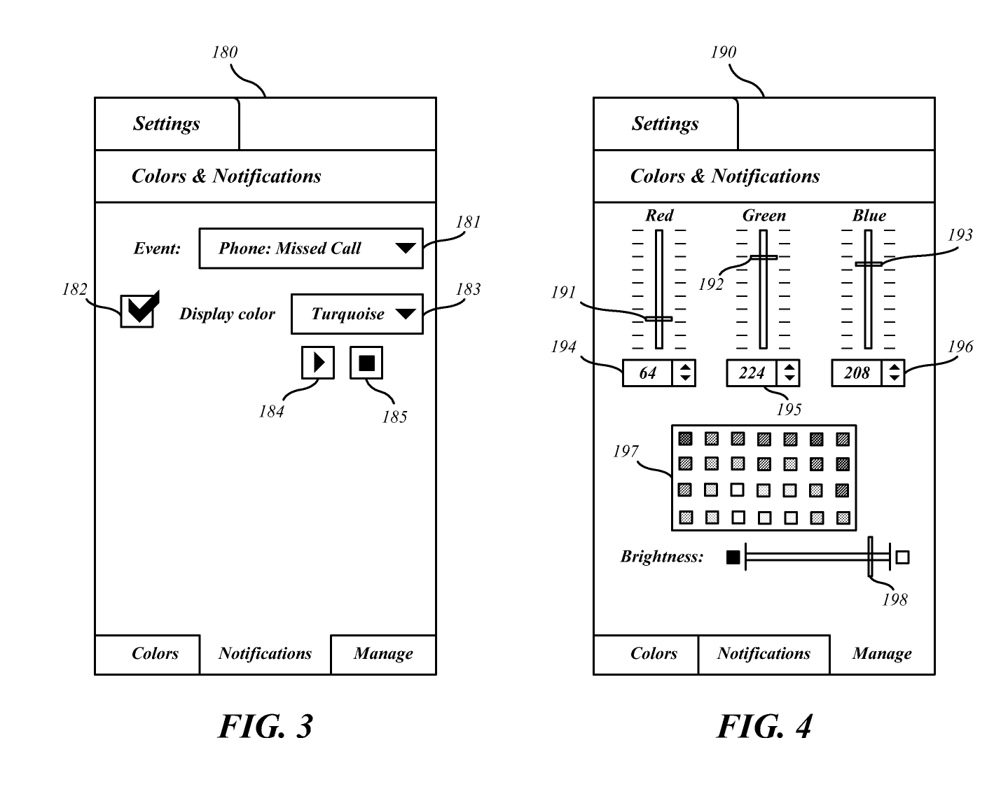

FIG. 3 illustrates one embodiment of a UI 180 which may be presented by the mobile computing device 100 for setting various colors and/or notifications. As shown, the UI 180 may comprise an event pick list 181 for selecting various events (e.g., missed call) associated with one of the user applications 142 (e.g., telephone application). The UI 180 also comprises a check box 182 for allowing the user to configure the mobile computing device 100 to illuminate based on the selected application event.

The UI 108 comprises a color pick list 183 for selecting a color (e.g., turquoise) by name to associate with the selected application event. In this embodiment, the UI 180 also comprises a preview button 184 for illuminating the mobile computing device 100 according to the selected color, and a stop button 185 for ending the preview.

FIG. 4 illustrates one embodiment of a UI 190 which may be presented by the mobile computing device 100 for selecting and/or adjusting various colors. As shown, the UI 190 may comprise slider bars 191-193 for setting and/or adjusting RGB color values (e.g., percentages, range values, binary notations) corresponding to a selected color (e.g., turquoise).

The UI 190 also may comprise data entry fields 194-196 for allowing the user to input and adjust RGB color values (e.g., binary notations) for a desired color. The UI 190 also may comprise a palette 197 including samples of available colors for allowing the user to select a desired color. In some implementations, the RGB color values may be associated with or mapped to a selected color (e.g., turquoise) such that selecting the desired color by name from the pick list 183 or from the palette 197 automatically populates the data entry fields with its associated set of RGB color values.

In this embodiment, the UI 190 comprises a brightness slider bar 198 for allowing the user to set illumination brightness. It can be appreciated that the UI 190 may comprise various other options for controlling visual effects.

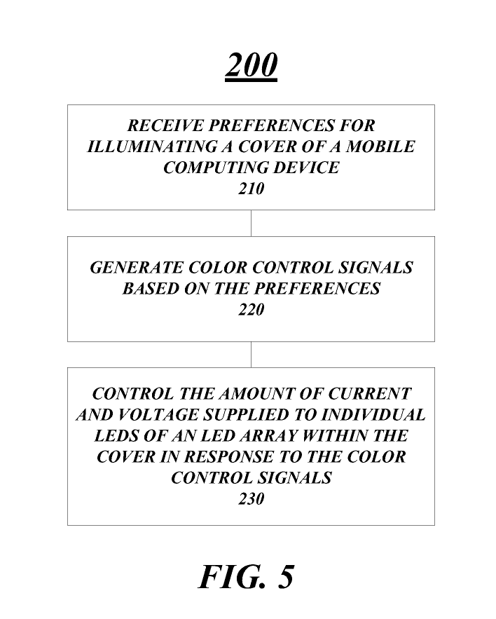

FIG. 5 illustrates one embodiment of a logic diagram 200, which may be representative of the operations executed by one or more embodiments described herein. In this embodiment, the logic diagram 200 may comprise receiving preferences set by a user for illuminating the cover of a mobile computing device (block 210); generating color control signals based on the preferences set by the user (block 220); and controlling the amount of current and voltage supplied to individual LEDs of a LED array light within the cover in response to the color control signals for achieving certain and relative intensities of red, green, and blue light emitted by the LED array corresponding to a selected color and effect (bock 230). It can be appreciated that the logic diagram 200 may comprise various other operations in accordance with the described embodiments.

In various embodiments, the logic diagram 200 may comprise, or be implemented as, executable computer program instructions. The executable computer program instructions may be implemented by software, firmware, a module, an application, a program, a subroutine, instructions, an instruction set, computing code, words, values, symbols or combination thereof. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The executable computer program instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

In various embodiments, the logic diagram 200 may comprise, or be implemented as, executable computer program instructions stored in an article of manufacture and/or computer-readable storage medium. The article and/or computer-readable storage medium may store executable computer program instructions that, when executed by a computer, cause the computer to perform methods and/or operations in accordance with the described embodiments. The article and/or computer-readable storage medium may be implemented by various systems and/or devices in accordance with the described embodiments. In such embodiments, a computer may include any suitable computer platform, device, system, or the like implemented using any suitable combination of hardware and/or software.

The article and/or computer-readable storage medium may comprise one or more types of computer-readable storage media capable of storing data, including volatile memory or, non-volatile memory, removable or non-removable memory, erasable or non-erasable memory, writeable or re-writeable memory, and so forth. Examples of computer-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other suitable type of computer-readable storage media in accordance with the described embodiments.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a computer, a firmware element embedded in hardware, or any combination thereof.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A mobile computing device comprising:
a cover including a light-emitting diode (LED) array comprising a plurality of light-emitting diodes (LEDs);
a processor comprising an application for receiving preferences from a user for illuminating the cover; and
an LED array control module to generate color control signals based on the preferences for controlling the amount of current and voltage supplied to individual LEDs of the LED array for achieving certain and relative intensities of light emitted by the LED array corresponding to a color selected from a plurality of available colors.

2. The mobile computing device of claim 1, the LED array comprising a red LED, a green LED, and blue LED.

3. The mobile computing device of claim 1, wherein the cover comprises multiple LED arrays.

4. The mobile computing device of claim 3, wherein the multiple LED arrays are attached to a common set of connectors.

5. The mobile computing device of claim 1, the light-emitting diode array positioned within the cover between an inner layer and an outer layer, the outer layer comprising a semi-opaque material, and the inner layer comprising a reflective material.

6. The mobile computing device of claim 1, wherein the cover comprises a detachable battery cover.

7. The mobile computing device of claim 1, wherein the available colors comprise a set of colors based on an additive color model.

8. The mobile computing device of claim 1, wherein the preferences allow the user to select a color by one or more of selecting from a pick list, selecting from a palette, and inputting color values.

9. The mobile computing device of claim 1, wherein the preferences allow the user to select a visual effect.

10. The mobile computing device of claim 1, wherein the preference allow a user to configure the cover to illuminate in response to one or more user applications.

11. The mobile computing device of claim 9, where the cover is configured to illuminate based on an event associated with a user application.

12. The mobile computing device of claim 1, further comprising one or more sensors for causing the cover to illuminate in response to an environmental condition.

13. The mobile computing device of claim 1, further comprising a LED driver for receiving the color control signals and for outputting regulated output voltage and current supplied by a power source to each of the LEDs of the LED array.

14. The mobile computing device of claim 1, wherein the mobile computing device is associated with a single stock keeping unit (SKU).

15. A method comprising:
receiving preferences for illuminating the cover of a mobile computing device, the cover including a light-emitting diode (LED) array comprising a plurality of light-emitting diodes (LEDs); and
generating color control signals based on the preferences for controlling the amount of current and voltage supplied to individual LEDs of the LED array within the cover for achieving certain and relative intensities of light emitted by the LED array corresponding to a color selected from a plurality of available colors.

16. The method of claim 15, wherein the light-emitting diode array is positioned within the cover between an inner layer and an outer layer, the outer layer comprising a semi-opaque material, and the inner layer comprising a reflective material.

17. The method of claim 15, wherein the preferences allow the user to perform one or more of selecting a visual effect, configuring the cover to illuminate in response to one or more user applications, configuring the cover to illuminate based on an event associated with a user application, and configuring the cover to illuminate in response to an environmental condition.

18. A computer-readable storage medium comprising executable computer program instructions that when executed enable a computing system to:
receive preferences for illuminating the cover of a mobile computing device, the cover including a light-emitting diode (LED) array comprising a plurality of light-emitting diodes (LEDs); and
generate color control signals based on the preferences for controlling the amount of current and voltage supplied to individual LEDs of the LED array light within the cover for achieving certain and relative intensities of light emitted by the LED array corresponding to a color selected from a plurality of available colors.

19. The computer-readable storage medium of claim 18, wherein the light-emitting diode array is positioned within the cover between an inner layer and an outer layer, the outer layer comprising a semi-opaque material, and the inner layer comprising a reflective material.

20. The computer-readable storage medium of claim 18, wherein the preferences allow the user to perform one or more of selecting a visual effect, configuring the cover to illuminate in response to one or more user applications, configuring the cover to illuminate based on an event associated with a user application, and configuring the cover to illuminate in response to an environmental condition.
